(19) United States
(12) Patent Application Publication
(10) Pub. No.: US 2022/0271630 A1
(43) Pub. Date: Aug. 25, 2022

(54) STATOR OF AN ELECTRIC MOTOR AND ELECTRIC MOTOR

(71) Applicant: Dr. Ing. h.c. F. Porsche Aktiengesellschaft, Stuttgart (DE)

(72) Inventors: Rolf Graef, Kornwestheim (DE); Johannes Stoll, Lorch (DE); Andreas Riedel, Bruck i. d. Opf. (DE)

(21) Appl. No.: 17/674,893

(22) Filed: Feb. 18, 2022

(30) Foreign Application Priority Data
Feb. 22, 2021 (DE) 10 2021 104 082.5

(51) Int. Cl. H02K 15/00; H02K 1/16; H02K 15/02

(52) U.S. Cl. CPC H02K 15/0081; H02K 1/16; H02K 15/02

(57) ABSTRACT

A stator (1, 10) for an electric motor is disclosed. The stator includes a laminated stator core (2, 11) and a plurality of hairpin-like elements (3, 12) of a metallic material, the plurality of hairpin-like elements having two longitudinal legs (4, 13) and a connecting section (5, 14) between the longitudinal legs (4, 13). The laminated stator core (2, 11) has a plurality of slots (6, 15), wherein each of the longitudinal legs (4, 13) of the hairpin-like elements (3, 12) is received in a slot (6, 15), wherein the connecting sections (5, 14) of the hairpin-like elements (3, 12) form an annular region (7, 16), wherein the hairpin-like elements (3, 12) each define a plane (18, 19) with their two longitudinal legs (4, 13), wherein the connecting section (5, 14) of the respective hairpin-like element (3, 12) is tilted out of the plane (18, 19).

### CROSS REFERENCE TO RELATED APPLICATIONS

This application claims benefit to German Patent Application No. DE 10 2021 104 082.5, filed on Feb. 22, 2021, which is hereby incorporated by reference herein.

### FIELD

The invention relates to a stator of an electric motor and to an electric motor, in particular for a motor vehicle.

### BACKGROUND

In motor vehicles, electric motors are known which have a stator with a number of hairpin-like elements, which are composed of a metallic element, having two longitudinal legs and a connecting section between the longitudinal legs. These elements are inserted with their legs into slots of a laminated stator core and are connected electrically at the ends of the legs by means of a winding overhang. In this case, the two legs and the connecting section lie in one plane and thus define the hairpin-like element. After the assembly of the hairpin-like elements with the laminated stator core, the connecting sections project in an axial direction and form a ring of connecting sections. Such hairpin-like elements, also known as hairpin conductors, are known from DE 10 2016 124 799 A1 or from DE 10 2017 103 128 A1. These hairpin-like elements can in this case be formed from a one-piece sheet-metal or wire part or from a plurality of metal strands which are designed to be connected to one another. Here, the connecting sections of the hairpin-like elements, when considered together, jointly form a ring which projects in the axial direction of the stator. Furthermore, it is found that the insertion of the hairpin-like elements into the laminated stator core is very difficult because the connecting sections interfere with the insertion of the hairpin-like elements.

### SUMMARY

In an embodiment, the present disclosure provides a stator for an electric motor comprising a laminated stator core and a plurality of metallic hairpin-like elements, each of the plurality of hairpin-like elements having two longitudinal legs and a connecting section between the longitudinal legs, and wherein: the laminated stator core has a plurality of slots configured to receive each of the longitudinal legs of the hairpin-like elements, the connecting sections of the hairpin-like elements form an annular region, and the longitudinal legs of each hairpin-like element defines a plane, wherein the connecting section of the respective hairpin-like element is tilted out of the plane.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a stator according to the prior art,

FIG. 2 shows a schematic view of a hairpin-like element according to the prior art,

FIG. 3 shows another schematic view of the hairpin-like element according to FIG. 2,

FIG. 4 shows a schematic view of a stator according to an embodiment of the invention,

FIG. 5 shows a schematic view of a hairpin-like element according to an embodiment of the invention,

FIG. 6 shows another schematic view of the hairpin-like element according to the embodiment of the invention as shown in FIG. 5,

FIG. 7 shows another schematic view of the hairpin-like element according to the embodiment of the invention as shown in FIG. 5,

FIG. 8 shows another schematic view of the hairpin-like element according to the embodiment of the invention as shown in FIG. 5,

FIG. 9 shows another schematic view of the hairpin-like element according to the embodiment of the invention as shown in FIG. 5,

FIG. 10 shows a schematic view of the method for tilting the connecting sections by means of a plug.

### DETAILED DESCRIPTION

In an embodiment, the present invention provides a stator and an electric motor having a stator which can be produced in a simple and space-saving manner. In an embodiment, a method for producing an improved stator is provided.

An embodiment of the invention relates to a stator for an electric motor, in particular for a motor vehicle, having a laminated stator core and having a plurality of hairpin-like elements, which are each composed of a metallic material, having two longitudinal legs and a connecting section between the longitudinal legs, wherein the laminated stator core has a plurality of slots, wherein each of the longitudinal legs of the hairpin-like elements is received in a slot, wherein the connecting sections of the hairpin-like elements form an annular region, wherein the hairpin-like elements each define a plane with their two longitudinal legs, wherein the connecting section of the respective hairpin-like element is tilted out of the plane. This makes the axial length of the stator shorter, and therefore less installation space is required for the stator. This also facilitates assembly if tilting ensures better accessibility to the slots in order to introduce the longitudinal legs into the slots.

In an embodiment, it is expedient if the hairpin-like elements each define a plane with their two longitudinal legs, wherein the connecting section of the respective hairpin-like element is tilted out of the plane at a first angle. This results in an angled design which is simple to produce and which achieves a significant reduction in the axial extent.

In some embodiments, the first angle is an acute angle, from 5° to 60°. In some embodiments, the first angle is from 10° to 40° or from 15° to 25°. This results in an angled design which is simple to produce and which achieves a significant reduction in the axial extent.

It is also advantageous if the connecting section is formed by two transverse legs, wherein the two transverse legs are arranged at a second angle to one another. This also ensures simplified production and a simple design.

It is also advantageous if the second angle is an angle of from 75° to 150°. In some embodiments the second angle is from 90° to 130° or from 100° to 110°. As a result, material is also saved since the connecting section is not too long.

It is also advantageous if the hairpin-like element comprises a sheet-metal strip, a wire element, or a multiplicity of sheet-metal strips or wire elements, i.e. for example a bundle of individual wires, for example as stranded conductors. In this way, the hairpin-like element can be selected from a suitable material, which can be matched to the performance data of the electric motor.

An embodiment of the invention relates to an electric motor, in particular for a motor vehicle, having a stator and having a rotor, wherein the stator is designed in accordance with the invention.

An embodiment of the invention relates to a method for producing a stator for an electric motor, in particular for a motor vehicle, having the following steps:
a. providing a laminated stator core having a plurality of slots,
b. providing a plurality of hairpin-like elements, which are each composed of a metallic material, having two longitudinal legs and a connecting section between the longitudinal legs,
c. inserting each of the longitudinal legs of the hairpin-like elements into a respective slot in the laminated stator core in such a way that the connecting sections of the hairpin-like elements form an annular region,
d. contacting the ends of the longitudinal legs,
   wherein
   the hairpin-like elements each define a plane with their two longitudinal legs, wherein
   the connecting section of the respective hairpin-like element is tilted out of the plane.

In this way, a method for producing an improved stator is achieved.

It is advantageous if the two longitudinal legs of the hairpin-like elements lie in one plane. In this case, the two longitudinal legs may or may not be aligned parallel to one another.

It is also advantageous if the tilting of the connecting section out of the plane of the longitudinal legs takes place before and/or after the insertion of the longitudinal legs into the slots. This enables the hairpin-like elements to be prefabricated and assembled already with a tilt, or they can be produced partially pre-tilted, and then, after assembly, final tilting takes place, or, as an alternative, tilting may take place only after the insertion of the longitudinal legs into the slots.

In an embodiment, the tilting-out is carried out by means of a drift plug after the introduction of the longitudinal legs. This has the advantage that all the connecting sections can be tilted simultaneously, and therefore only one working step is required for this purpose.

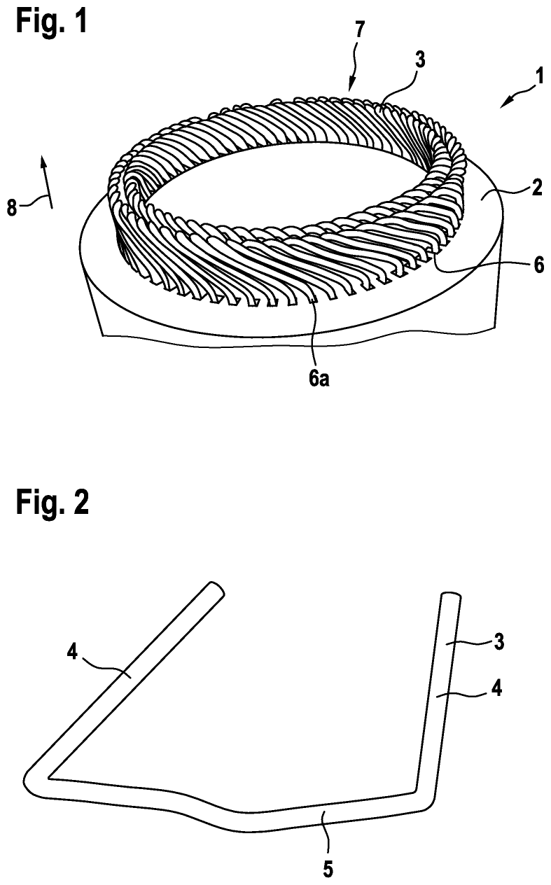

FIG. 1 shows a schematic view of a stator 1 according to the prior art. The stator 1 according to the prior art is a stator 1 of an electric motor. The stator 1 has a laminated stator core 2 and a multiplicity of hairpin-like elements 3.

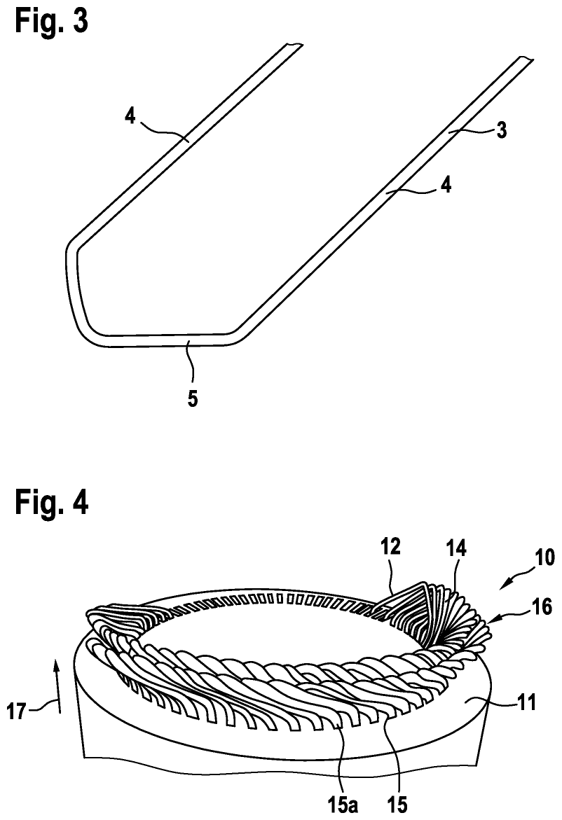

Here, FIGS. 2 and 3 show a corresponding partial view of a hairpin-like element 3 according to the prior art. The hairpin-like element 3 is composed of a metallic material and has two longitudinal legs 4 and a connecting section 5 between the longitudinal legs 4.

The laminated stator core 2 has a multiplicity of slots 6. The slots are optionally provided with a slot insulation 6a, as it were being lined. In this case, the hairpin-like elements 3 are arranged in such a way that each of the longitudinal legs 4 of the hairpin-like elements 3 is received in a slot 6, and the connecting sections 5 of the hairpin-like elements 3 form an annular region 7 which projects in the axial direction 8 of the stator 1.

FIGS. 2 and 3 show that the hairpin-like element 3 with its two longitudinal legs 4 and the connecting section 5 each define a plane and are correspondingly of approximately flat design. Here, the hairpin-like elements 3 have a three-dimensional shape, wherein the connecting section is bent in accordance with the slot diameter.

However, the material of the hairpin-like elements 3 may be twisted on itself in order to adapt the multiplicity of hairpin-like elements to form the stator. Here, the longitudinal legs 4 and the connecting section 5, at least when considered roughly, define a common plane with slight deviations from the plane.

FIG. 4 shows another schematic view of a stator 10 according to an embodiment of the invention. The stator 10 according to the invention is in this case a stator 10 of an electric motor, in particular of a motor vehicle. The stator 10 has a laminated stator core 11 and a multiplicity of hairpin-like elements 12. In FIG. 4, however, not all of the hairpin-like elements 12 have been installed, which is why only some of the hairpin-like elements 12 can be seen. When all hairpin-like elements 12 have been installed, they form an annular region.

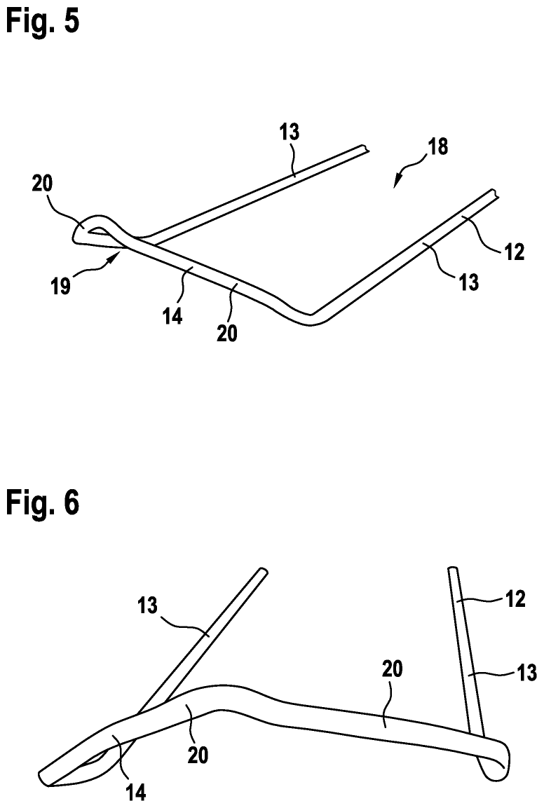

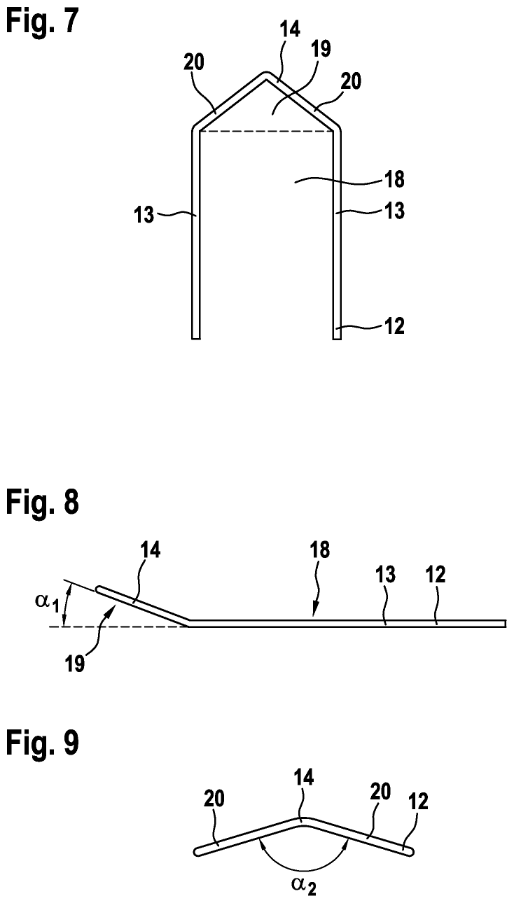

Here, FIGS. 5 to 9 show a corresponding view or partial view of a hairpin-like element 12 according to the invention. The hairpin-like element 12 is composed of a metallic material and has two longitudinal legs 13 and a connecting section 14 between the longitudinal legs 13. In some embodiments, a configuration consisting of a bundle of individual wires is preferred.

The laminated stator core 11 has a multiplicity of slots 15, which are lined with a slot insulation 15a. In this case, the hairpin-like elements 12 are arranged in such a way that each of the longitudinal legs 13 of the hairpin-like elements 12 is received in a slot 15, and the connecting sections 14 of the hairpin-like elements 12 form an annular region 16 which projects in the axial direction 17 of the stator 10.

FIGS. 5 to 9 show that the hairpin-like element 12 forms a first plane 18 with its two longitudinal legs 13, and the connecting section 14 is tilted out of this first plane 18. In this case, the connecting section too defines a second plane 19, which is tilted with respect to the first plane 18. Similarly, the material of the hairpin-like elements 12 may also be twisted on itself in order to adapt the multiplicity of hairpin-like elements 12 to form the stator 10.

In this case, the hairpin-like elements 12 each define a first plane 18 with their two longitudinal legs 13, wherein the connecting section 14 of the respective hairpin-like element 12 is tilted out of the plane 18 at a first angle α1.

In some embodiments, the first angle α1 is preferably an acute angle from 5° to 60°. In some embodiments, the first angle α1 is from 10° to 40° or from 15° to 25°.

FIGS. 5, 6, 7 and 9 also show that the connecting section 14 is formed by two transverse legs 20, wherein the two transverse legs 20 are arranged at a second angle α2 to one another. In some embodiments, the second angle α2 is preferably an angle in the range from 75° to 150°. In some embodiments the second angle α2 is from 90° to 130° or from 100° to 110°.

In this case, the hairpin-like element 12 according to the invention can consist of a sheet-metal strip, of a wire element or of a plurality of sheet-metal strips or wire elements, such as strands.

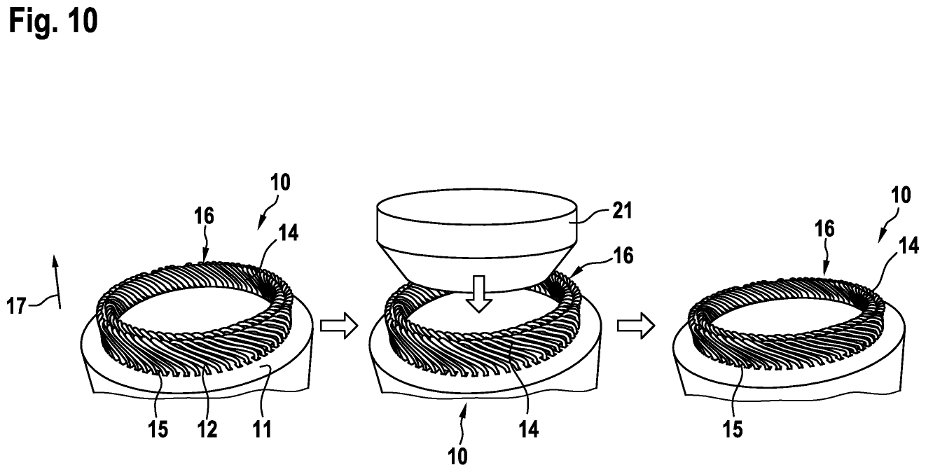

FIG. 10 indicates a method for producing a stator 10 for an electric motor, in particular for a motor vehicle. The method has the following steps:
a. providing a laminated stator core 11 having a multiplicity of slots 15,
b. providing a plurality of hairpin-like elements 12, which are each composed of a metallic material, having two longitudinal legs 13 and a connecting section 14 between the longitudinal legs 13,
c. inserting each of the longitudinal legs 13 of the hairpin-like elements 12 into a respective slot 15 in the laminated stator core 11 in such a way that the connecting sections 14 of the hairpin-like elements 12 form an annular region 16, and
d. contacting the ends of the longitudinal legs 13.

In this case, the two longitudinal legs 13 of the hairpin-like elements 12 are designed in such a way that the hairpin-like elements 12 each define a plane 18, wherein the connecting section 14 of the respective hairpin-like element 12 is tilted out of the plane 18.

Here, the tilting of the connecting section 14 out of the plane 18 of the longitudinal legs 13 can take place before and/or after the insertion of the longitudinal legs 13 into the slots 15.

FIG. 10 indicates that the tilting-out is carried out by means of a drift plug 21 after the introduction of the longitudinal legs 13 into the slots 15. In the left-hand illustration in FIG. 10, the stator is assembled, with the connecting sections 14 still being arranged in the plane 18 and thus forming the annular region 16, which projects a long distance in the axial direction. In the central illustration, a drift plug 21 is placed on this annular region 16 in order to bend the connecting sections 14 and tilt them out of the plane 18. In the right-hand illustration in FIG. 10, the connecting sections 14 are tilted out of the plane 18, and, as a result, they form the annular region 16, which is flattened and projects less far in the axial direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 stator
2 laminated stator core
3 element
4 longitudinal leg
5 connecting section
6 slot
6a slot insulation
7 annular region
8 axial direction
10 stator
11 laminated stator core
12 element
13 longitudinal leg
14 connecting section
15 slot
15a slot insulation
16 annular region
17 axial direction
18 first plane
19 second plane
20 transverse leg
21 drift plug

1. A stator for an electric motor, comprising:
a laminated stator core; and
a plurality of metallic hairpin-like elements, each of the plurality of hairpin-like elements having two longitudinal legs and a connecting section between the longitudinal legs, and wherein:
the laminated stator core has a plurality of slots configured to receive each of the longitudinal legs of the hairpin-like elements,
the connecting sections of the hairpin-like elements form an annular region, and
the longitudinal legs of each hairpin-like element defines a plane, wherein the connecting section of the respective hairpin-like element is tilted out of the plane.

2. The stator as claimed in claim 1, wherein the connecting section of each hairpin-like element is tilted out of the plane of the respective hairpin-like element at a first angle.

3. The stator as claimed in claim 2, wherein the first angle is an acute angle between 5° to 60°.

4. The stator as claimed in claim 1, wherein the connecting section is formed by two transverse legs and the two transverse legs are arranged at a second angle relative to one another.

5. The stator as claimed in claim 4, wherein the second angle is between 75° to 150°.

6. The stator as claimed in claim 1, wherein each of the hairpin-like elements comprise a sheet-metal strip, a wire element, a plurality of sheet-metal strips, or a plurality of wire elements.

7. An electric motor for a motor vehicle comprising a stator as claimed in claim 1 and a rotor.

8. A method for producing a stator for an electric motor, the method comprising:
a. providing a laminated stator core having a plurality of slots,
b. providing a plurality of hairpin-like elements from a metallic material, each of the plurality of hairpin-like elements having two longitudinal legs and a connecting section between the longitudinal legs,
c. inserting each of the longitudinal legs of the hairpin-like elements into a respective slot in the laminated stator core such that the connecting sections of the hairpin-like elements form an annular region, and
d. contacting the ends of the longitudinal legs,
wherein the longitudinal legs of each hairpin-like element defines a plane and the connecting section of the respective hairpin-like element is tilted out of the plane.

9. The method as claimed in claim 8, wherein the tilting of the connecting section out of the plane of the longitudinal legs takes place after the insertion of the longitudinal legs.

10. The method as claimed in claim 9, wherein a drift plug is configured to tilt the connecting section.
